(19) United States
(12) Patent Application Publication
(10) Pub. No.: US 2026/0211714 A1
(43) Pub. Date: Jul. 23, 2026

(54) METHOD AND APPARATUS FOR ORCHESTRATING MICROSERVICE-BASED NETWORKS

(71) Applicant: SAMSUNG ELECTRONICS CO., LTD., Suwon-si, Gyeonggi-do (KR)

(72) Inventors: Andrea TASSI, Staines, Middlesex (GB); Yue WANG, Staines, Middlesex (GB); Daniel WARREN, Staines, Middlesex (GB)

(21) Appl. No.: 19/140,882

(22) PCT Filed: Dec. 8, 2023
(86) PCT No.: PCT/KR2023/020152

§ 371 Date: Jun. 18, 2025

(30) Foreign Application Priority Data
Dec. 21, 2022 (GB) 2219405.4
Nov. 16, 2023 (GB) 2317577.1

(51) Int. Cl. G06F 9/455

(52) U.S. Cl. CPC G06F 9/45558; G06F 2009/4557

(57) ABSTRACT

The present disclosure relates to a 5G communication system or a 6G communication system for supporting higher data rates beyond a 4G communication system such as long term evolution (LTE). Disclosed is a method performed by a network entity for optimising clustering of microservices and overseeing the lifecycle of the microservices. the method comprises: acquiring status information related to available bare-metal resources in the network; determining to re-cluster microservices into a plurality of containerised images based on the status information; and re-clustering the microservices.

### TECHNICAL FIELD

The present disclosure relates to wireless communication system. More specifically, the present disclosure relates to orchestrating microservice-based networks in wireless communication system.

### BACKGROUND ART

Considering the development of wireless communication from generation to generation, the technologies have been developed mainly for services targeting humans, such as voice calls, multimedia services, and data services. Following the commercialization of 5G (5th generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bit per second (bps) and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz (THz) band (for example, 95 gigahertz (GHz) to 3THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, Radio Frequency (RF) elements, antennas, novel waveforms having a better coverage than Orthogonal Frequency Division Multiplexing (OFDM), beamforming and massive Multiple-input Multiple-Output (MIMO), Full Dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, Orbital Angular Momentum (OAM), and Reconfigurable Intelligent Surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, High-Altitude Platform Stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of Artificial Intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as Mobile Edge Computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended Reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

### DISCLOSURE OF INVENTION

### Technical Problem

Currently, there are needs to enhance orchestrating microservice-based networks in wireless communication system.

### Solution to Problem

According to embodiments of the present disclosure, a method performed by a network entity in a wireless communication system is provided. The method comprises acquiring status information related to available bare-metal resources; based on the status information determining to re-cluster microservices into a plurality of containerised images; and re-clustering the microservices.

According to embodiments of the present disclosure, a method performed by a microservice clustering agent (MCA) entity in a wireless communication system is provided. The method comprises acquiring status information related to available bare-metal resources; transmitting the status information to microservice orchestrating agent (MOA) entity; receiving re-cluster information for re-clustering microservices into a plurality of containerised images; and re-clustering the microservices based on the re-cluster information.

According to embodiments of the present disclosure, a method performed by a microservice orchestrating agent (MOA) entity in a wireless communication system is provided. The method comprises receiving, from a microservice clustering agent (MCA) entity, status information related to available bare-metal resources; determining whether to re-cluster microservices into a plurality of containerised images based on the status information; and transmitting, to the MCA entity, re-cluster information based on the determining.

### BRIEF DESCRIPTION OF DRAWINGS

For a better understanding of the invention, and to show how embodiments of the same may be carried into effect, reference will now be made, by way of example only, to the accompanying diagrammatic drawings in which:

FIG. 1 illustrates a high level model of a 5G Core (5GC) according to embodiments of the present disclosure;

FIG. 2 illustrates an exemplary overall execution graph of the user equipment (UE) Registration and uplink (UL)/downlink (DL) protocol data unit (PDU) Session Establishment procedures according to embodiments of the present disclosure;

FIG. 3 illustrates an example of NF-based and procedure-based monoliths according to embodiments of the present disclosure;

FIG. 4 illustrates an example of mapping of monolithic instances onto two bare-metal server according to embodiments of the present disclosure;

FIG. 5 illustrates an example of mapping of microservices (clustered in multiple container instances) onto two bare-metal servers according to embodiments of the present disclosure;

FIG. 6 illustrates an example of the logical, microservice and container plane of 5GC according to embodiments of the present disclosure;

FIG. 7 illustrates an exemplary call graph for the case where re-clustering is not needed according to embodiments of the present disclosure;

FIG. 8 illustrates an exemplary call graph for the case where re-clustering is needed according to embodiments of the present disclosure;

FIG. 9 illustrates a table showing certain central processing unit (CPU) parameters according to embodiments of the present disclosure;

FIG. 10 illustrates a CPU footprint graph for an NF-monolith case according to embodiments of the present disclosure;

FIG. 11 illustrates a CPU footprint for a procedure-based monolith case according to embodiments of the present disclosure;

FIG. 12 illustrates a CPU footprint for a microservice-based case according to embodiments of the present disclosure;

FIG. 13 is a block diagram illustrating a structure of a user equipment (UE) according to embodiments of the present disclosure;

FIG. 14 is a block diagram illustrating a structure of a base station (BS) according to embodiments of the present disclosure; and

FIG. 15 is a block diagram illustrating a structure of a network entity (NE) according to embodiments of the present disclosure.

Throughout the drawings, it should be noted that like reference numbers are used to depict the same or similar elements, features, and structures.

### BEST MODE FOR CARRYING OUT THE INVENTION

The present invention relates to an improved technique for orchestrating microservice-based networks. It provides particular, but not exclusive, utility in the field of core networks (CN) of Fifth Generation, 5G, telecommunication networks, which will be used to exemplify the invention. However, the skilled person will readily realise that other networks and systems may benefit from the following disclosure.

In the following, reference is made to Artificial Intelligence (AI) and Machine Learning (ML) techniques and procedures and the skilled person will readily appreciate the context within which these operate. Particular areas of relevance to the invention include Federated Learning over wirelessly connected devices. Coded Federated Learning, Stragglers, Fountain Coding. Embodiments of the invention aim to address shortcomings in these areas and others not referenced explicitly herein.

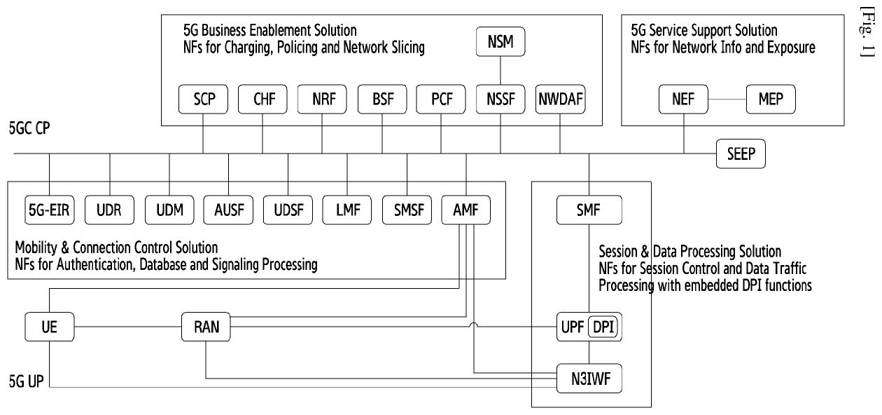

More particularly, in the domain of mobile networks, 3GPP's Release 15 detailed the adoption of the Service-Based Architecture (SBA) principle to define the Control Pane (CP) and User Plane (UP) functionalities of mobile core networks. As such, the 5G Core (5GC) consists of a collection of Network Functions (NFs) that can be orchestrated and optimised independently. The resulting SBA of the 5GC is shown in FIG. 1. FIG. 1 illustrates a high level model of a 5G Core (5GC) according to embodiments of the present disclosure. The details are not expanded upon herein since the skilled person will be familiar with this SBA, but note that FIG. 1 shows four main groupings: 5G Business Enablement Solution; 5G Service Support Solution Mobility and Connection Control Solution; and Session and Data Processing Solution.

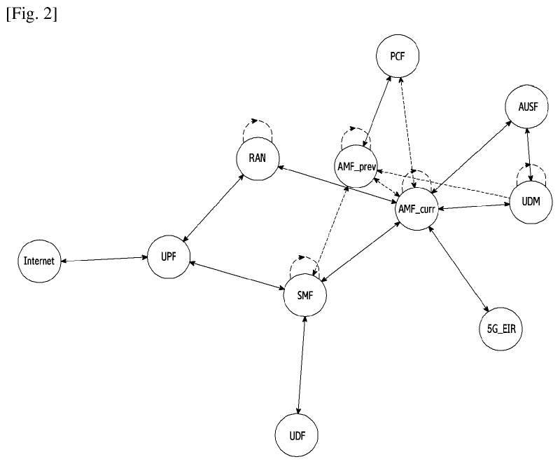

With regard to the Control Plane, it has been established that the decomposition of the 5GC into multiple NFs leads to certain issues, including:
The rapid increase of the overall communications among NFs, which is particularly evident when NFs are implemented in a stateless fashion, and the number of Ues engaging with the CP, for instance, in case of UE seeking to be registered or deregistered, is large. In these scenarios, NFs have to resort to gathering the necessary inputs from database entities serving as state databases.
Scalability issues, CP procedures often result in execution paths involving multiple NFs, where the same NFs are visited multiple times in the same execution path. This makes it impractical to offload some NFs to the edge having the same NFs to communicate with other NFs non-deployable to the edge. An example of these scalability issues is given by the UE Registration and UL/DL PDU Session Establishment procedures (see: 3GPP Technical Specification Group Services and System Aspects, “3GPP TS 23.502: Procedures for the 5G System (5GS) Stage 2 (Release 17) v.17.6.0,” Technical Specification, October 2022.), which are characterised by an overall execution graph (defined as the union of the considered execution paths) shown in FIG. 2. FIG. 2 illustrates an exemplary the overall execution graph of the User Equipment (UE) registration and Uplink (UL)/Downlink (DL) Protocol Data Unit (PDU) session establishment procedures according to embodiments of the present disclosure.

Yet, ultimately, 3GPP's design principles for each NF are purely service-based. In other words, from the logic perspective, each NF is modelled as a collection of services. In turn, a service may subscribe to other services to gather the required inputs and provide its outputs to its subscribers.

With these regards, arguments have been made against grouping services on a per-NF-basis. Instead, it has been proposed to cluster services (spanning multiple NFs) on a per-procedure basis. One proposal for the UE Registration procedure grouped the relevant services from the AUSF, UDM, NRF, AMF, PCF and UDR NFs into a single “meta-NF” called RegistrationNF. In doing so, both the procedure completion time and the overall number of messages (intended as messages exchanged between different services under the form of HTTP/SCTP-encapsulated messages) drastically reduces if compared to a 5GC implementation where services are grouped on a per-NF basis.

As expected, 3GPP as an organisation does not concern with the issues of how services and the inter-service communications are supposed to be implemented. NFs can be implemented in a stand-alone piece of software (hereafter referred to as a monolithic artefact) where its services typically are implemented as atomic procedures (e.g., C/C++functions). In this context, communication among services pertaining to the same NF is straightforward: it would simply be a function calling another function by employing the well-known software design pattern known as Observer.

Examples of monolithic artefacts in the context of 5GC implementations are: Open5GS (see www.open5gs.org) and Free5GC (see www.free5gc.org). In monolithic artefacts, network-based communications take place when a service in a NF wishes to send/receive a message to/from another service pertaining to another NF or to a state database. At the same time, the proposed solution referred to above can be regarded as a monolithic artefact-type implementation, where the RegistrationNF is an example of monolithic artefact grouping services from different NFs. In doing so, the overall reduction in network interactions measured is solely obtained by replacing network messages with function calls.

Monolith artefacts are associated with problems including limited scalability and technology lock-ins.

Especially in the context of complex 5GC procedures, limited scalability may be associated with non-negligible memory or computational resources. Given that an instance of a monolithic artefact can only run in a single bare-metal server, bare-metal servers may be underutilised. That is the case when the maximum number of replicas of a monolithic artefact are running on a bare-metal server, and there are no other artefacts (minute enough in terms of resource footprint) that can be accommodated in the remaining available resource on the server.

With regard to technology lock-ins, developers wishing to add another service are bound to use the same language and frameworks adopted in the artefact.

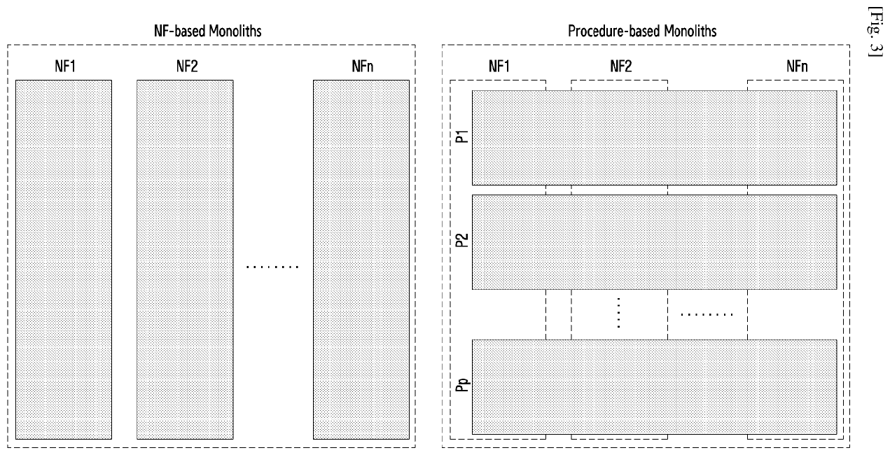

The prior art advocates for a procedural-based reorganisation of 3GPP's NFs where services associated with each NF are not grouped on the basis of the NF they belong to but on the basis of the procedure (ideally spanning multiple NFs) they are involved in. In doing so, the traditional monolithic paradigm of an NF is replaced with another monolith that spans across multiple NFs as shown in FIG. 3. FIG. 3 illustrates an example of NF-based and procedure-based monoliths according to embodiments of the present disclosure. This shows a representation of NF-based monoliths on the left of the figure and procedure-based monoliths on the right of the figure.

By definition, monolithic artefacts cannot be partitioned at runtime into multiple artefacts. Hence, monoliths can only be packaged into one software image to be executed as one container.

Regardless of whether NF-based or procedure-based monoliths are in use (as shown in FIG. 3), the systems of the prior art make it possible for a monolith to be packaged as a single software image (e.g., Docker image) and run as single or multiple instances (e.g., Kubernetes replica pods) depending on the requested load. This functionality is typically achieved by means of a Kubernetes horizontal pod autoscaler. Since each monolithic instance shall run on the same bare-metal server, this makes it hard for prior art auto-scaling solutions to efficiently accommodate (potentially) resource-hungry instances onto bare-metal servers efficiently.

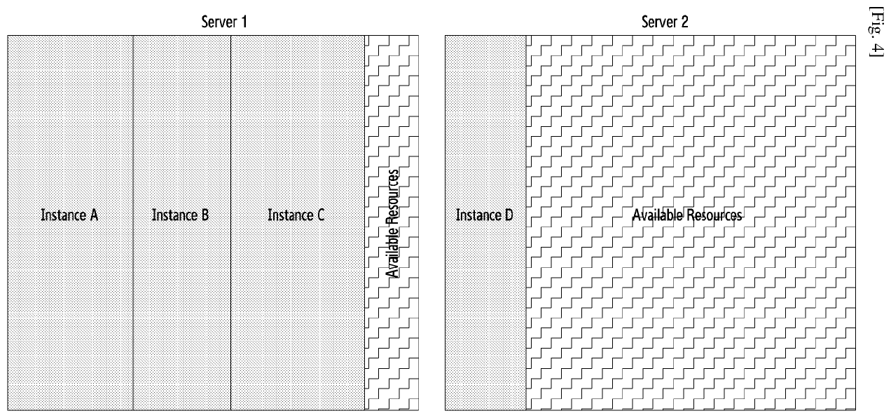

As such, this may result to the situation shown in FIG. 4 where monolithic instances A, B and C can be accommodated onto bare-metal server 1 and instance D is run in bare-metal server 2—thus, leaving server 1 with a non-negligible amount of available resources that are not enough to accommodate any other monolithic instance. FIG. 4 illustrates an example of mapping of monolithic instances onto two bare-metal server according to embodiments of the present disclosure. This phenomenon is also known as bin packing inefficiency.

According to the present invention there is provided an apparatus and method as set forth in the appended claims. Other features of the invention will be apparent from the dependent claims, and the description which follows.

According to a first aspect of the present invention, there is provided a method of operating a telecommunication network, the network comprising a Network Function, NF, operable to optimise clustering of microservices and further operable to oversee the lifecycle of the microservices, the method comprising the steps of: gathering status information related to bare-metal resources in the network, in terms of resources that are allocated and/or available; employing the status information to determine whether to re-cluster the microservices into a plurality of containerised images; and if so determined, re-clustering the microservices into a plurality of containerised images.

In an embodiment, there is further provided the step of instructing termination of at least one of the currently running containerised images; and executing one or more newly generated containerised images, ensuring that each such instance of the one or more containerised images does not exceed an allotted bare-metal resource slot.

In an embodiment, status information is gathered either periodically or on-demand.

In an embodiment, the step of gathering status information comprises the bare-metal resources submitting a snapshot notification to a Microservice Clustering Agent, MCA.

In an embodiment, the MCA submits the snapshot notification to a Microservice Orchestrating Agent, MOA, to determine if reclustering is required and, if so, the MOA triggers a reclustering based on an optimisation policy.

In an embodiment, the MOA notifies the MCA details of one or more container instances to be terminated, a recipe to assemble new images and related container parameters.

In an embodiment, for any new image to be assembled, the MCA interrogates a Microservice Image Cache, MIC, to determine whether any or all of the new images to be assembled have been previously compiled and to use these if available.

In an embodiment, any container instance requiring termination is gracefully killed by the MCA.

According to a second aspect of the present invention, there is provided apparatus arranged to perform the method of the first aspect.

According to the present invention, there is provided a definition of a novel control entity responsible for clustering a set microservices underpinning the services offered by a 5G Core (5GC). The aforementioned cluster agent is herein referred to a as Microservice Clustering Agent (MCA). The MCA has one or more of the following functions:
Gathers on a periodic-and/or on-demand-basis the status of the bare-metal resources (both allocated and available). Unlike prior art technologies (e.g., Prometheus) that are capable of gathering the status of the bare-metal resources and reporting it to the orchestrating components that are not part of the 5GC, embodiments of the invention expose the bare-metal status directly to the 5GC;
Oversees the dynamic re-clustering of microservices;
Enforces the mapping of each microservice cluster onto one containerised image (e.g., Docker images, LXC images, etc.). A containerised image may be retrieved from a dedicated cache (e.g., a private or public Docker register), hereafter referred to as Microservice Image Cache (MIC). If a specific containerised image is not present in the MIC, the MCA will generate the image and cache it in the MIC;
Enforces the execution of each containerised image (as one or more replicas) onto a given set of bare-metal processing nodes;
Ensure each replica will not exceed a given amount of bare-metal resources (e.g., maximum CPU footprint, RAM/storage footprint, etc.).

According to the present invention, there is also provided a definition of a novel Microservice Orchestrating Agent (MOA) responsible for:
Overseeing the creation of clusters of microservices by enforcing a set of clustering criteria (defining a clustering policy) in a dynamic fashion (via the MCA) through:
A non-AI-based optimisation policy (e.g., procedure-based heuristic)
An AI-based module.

Advantageously, embodiments of the present invention define a framework permitting the clustering of one or more microservices into one container via the MCA and MIC. This approach makes it possible for a single 3GPP's procedure to be executed by one or more containers.

Although a few preferred embodiments of the present invention have been shown and described, it will be appreciated by those skilled in the art that various changes and modifications might be made without departing from the scope of the invention, as defined in the appended claims.

In the following description, certain definitions and pre-requisites are required. There are set out below.

Embodiments of the present invention apply to strictly non-monolithic systems. To establish the pre-requisite to this invention, the following definitions are provided:
[Definition 1] An execution stage is a statement within a coded procedure.
[Definition 2] An execution path is a direct graph where the edges are execution stages.
[Definition 3] A microservice is an entity entirely defined by the union of one or more execution paths. Inputs to a microservice can only traverse (and be transformed by) one execution path at a time. The output of a microservice is entirely determined by its inputs (stateless assumption). Microservices may communicate with other microservices in a plurality of communication patterns that shall entirely rely upon network interactions.

It is assumed that the following facts hold true:
[Pre-Requisite 1] The set of functionalities associated with a service pertaining to an NF are mapped onto one or more microservices.
[Pre-Requisite 2] It shall be possible to run one or more microservices in one container.
[Pre-Requisite 3] From the point of view of inter-microservice network communications, the communication between a pair of microservices located in the same container shall be indistinguishable from the case where the microservices are located in different containers.

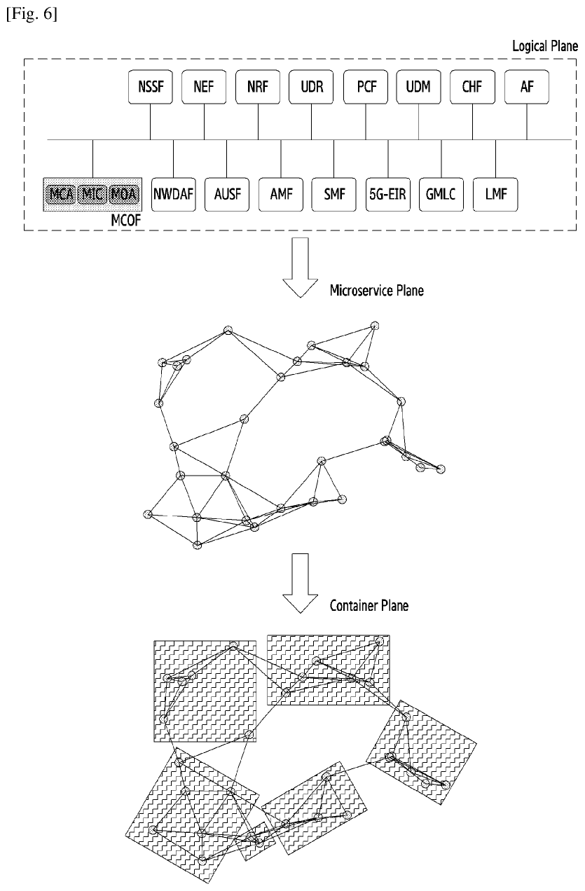

FIG. 6 illustrates an example of the logical, microservice and container plane of 5GC according to embodiments of the present disclosure.

As shown in FIG. 6, from the logical perspective (logical plane), there is provided an additional NF to the 5GC called Microservice Clustering and Orchestrating Function (MCOF), combining the MCA, MIC and MOA as services. Due to Pre-Requisite 1, mentioned above, the services of the 5GC are delivered by a network of microservices (microservice plane) and, in turn, one or more microservices are grouped onto an image that is then run in a containerised fashion (container plane formed by container instances). It should be noted that the MCOF may also be executed as a set of microservices containerised in one or more containers.

Furthermore, the clustering and orchestrating functions are logically grouped as a new NF due to the following reasons, because even though the examples presented herein relate primarily to 5GC, embodiments of the invention may be used in other systems.

At the same time, as standardisation efforts move beyond 5G, to future systems, such as 6G and beyond, the state-of-the-art in 6G clearly shows a focus on self-optimisation and self-orchestration. As such, the adoption of MCOF would be able to unlock those capabilities in the core, from the logical plane and in a top-down fashion.

Two further definitions are hereby provided:
[Definition 4] An “image recipe”, which is the basic image definition (common to every image), includes the list of microservices that shall be included in a target image and their execution graph.
[Definition 5] A container instance is an image that is being executed. Should there be more than one container instance referring to the same image, this set of instances is regarded as a replica set.

In FIG. 6, the MCA periodically and/or in an event-based fashion acquires a snapshot of the available/allocated resources at the level of the bare metal. The available/allocated bare metal resources are then communicated to the MOA, which may decide not to re-cluster any of the microservices. Alternatively, on the basis of its internal logic (optimised clustering task), the MOA may decide to refresh the microservice clusters.

Examples of clustering policy goals may include:
Minimisation of the number of bare-metal servers in use (energy reduction);
Dynamic increase/decrease in replica sets to cope with increased load at the core network with the intent of maximising the system availability;
Dynamic relocation of container instances from a centralised location (e.g., data centre) to edge bare-metal servers and vice versa with the intent of minimising the time needed for a 3GPP's procedure to complete—a typical use case would be the UE registration procedure that is being requested by UEs taking part in a massive access-type network.

If required, the MOA provides the MCA with the list of container instances to be terminated, the recipe to assemble new images and the related container parameters. Container parameters apply to each replica in a replica set and may include (but is not limited to) the following information:
The maximum CPU footprint (e.g., number of cores)
The maximum memory footprint
The maximum storage footprint
The maximum network I/O footprint.
The number of replicas that may be executed at the same time.
Upon receiving the aforementioned information, the MCA interrogates the MIC to check if one or more images that are expected to be generated have already been generated in the past. If so, MIC provides MCA with the cached images. Otherwise, new images are generated. Then, the container instances marked to be terminated are terminated, and the new replica sets are executed. The IDs of the newly created replica sets are communicated to the MOA.

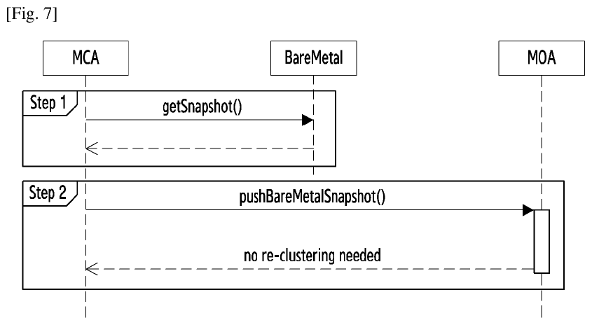

FIG. 7 illustrates an exemplary call graph for the case where re-clustering is not needed according to embodiments of the present disclosure. FIG. 7 shows the call graph in a case when the MOA decides not to trigger a re-clustering. In particular, this translates into the following procedure:
MCA requests a snapshot of the allocated/available resources to the bare-metal plane (getSnapshot( )). This step can also be replaced by an unsolicited snapshot notification from the bare-metal;
MCA submits the resource snapshot to MOA (pushBareMetalSnapshot( )) for evaluation. In this case, MOA decides not to trigger a re-clustering.

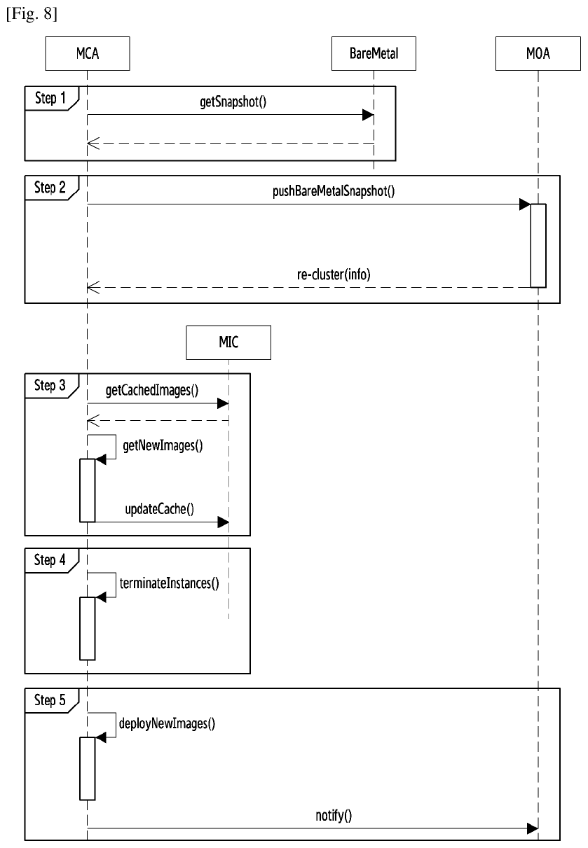

FIG. 8 illustrates an exemplary call graph for the case where re-clustering is needed according to embodiments of the present disclosure. FIG. 8 shows the call-graph in a case when the MOA decides to trigger a re-clustering. In particular, this translates into the following procedure:
MCA requests a snapshot of the allocated/available resources to the bare-metal plane (getSnapshot( )). This step can also be replaced by an unsolicited snapshot notification from the bare-metal;
MCA submits the resource snapshot to MOA (pushBareMetalSnapshot( )) for evaluation. In this case, MOA decides to trigger a re-clustering on the basis of the adopted non-AI-/AI-based optimisation policy. As such, MOA notifies MCA with:
list of container instances to be terminated
the recipe to assemble new images
related container parameters;

For each of the new images that MOA requested to generate, MCA interrogates MIC to check if some or all the new images that are expected to be generated have been previously compiled. Existing images are pulled from MIC, and (potentially) new images are generated;

Container instances deemed to be terminated are gracefully killed by MCA.

The new set of images to be executed are deployed by MCA. The IDs of the newly executed images are notified to MOA.

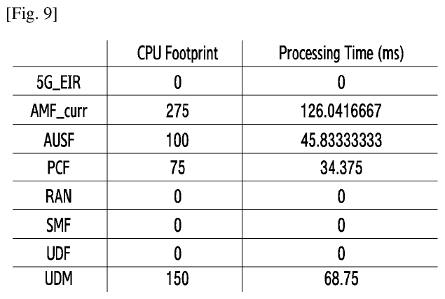

Thanks to the activities of the MOA, MCA can dynamically generate execution graphs of microservices to be grouped into the same container. In doing so, it is possible to significantly increase bin packing efficiency. As an example, consider a 5GC serving only UE registration requests. The following will refer to CPU footprint and processing time data obtained by processing certain sample results. Each UE registration request is assumed to last 275 ms in a system serving 4500 UEs equally split among 30 gNBs. Furthermore, in this example, reference is made to the per-NF CPU footprint and processing time reported in the table shown in FIG. 9. FIG. 9 illustrates a table showing certain central processing unit (CPU) parameters according to embodiments of the present disclosure.

FIG. 10 illustrates a CPU footprint graph for an NF-monolith case according to embodiments of the present disclosure. FIG. 10 shows the CPU footprint of each NF involved in the execution of a single UE registration procedure as a function of time, in the case of NF-based monolith. Different references (A, B, C, D) refer to different NFs. It is observed that about 47% of the overall procedure execution time is dominated by AMF-specific operations (A).

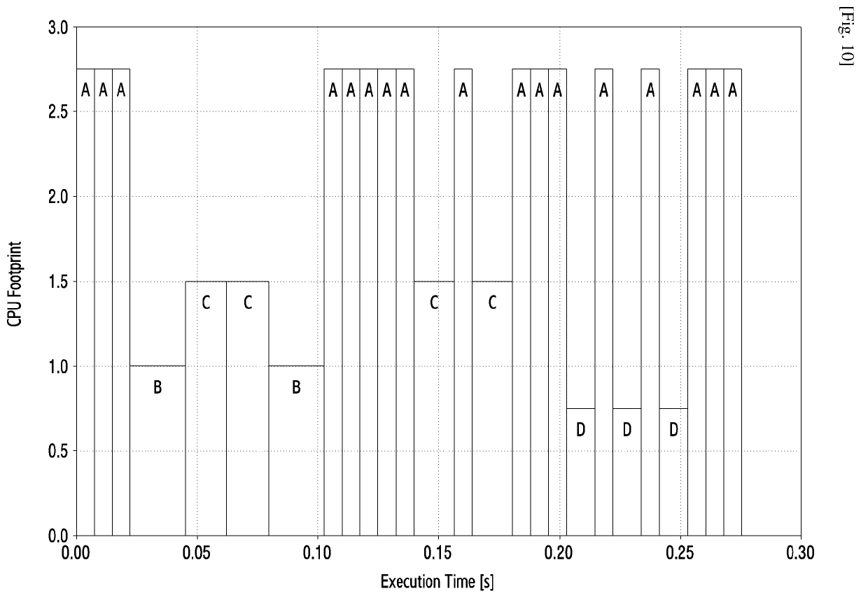

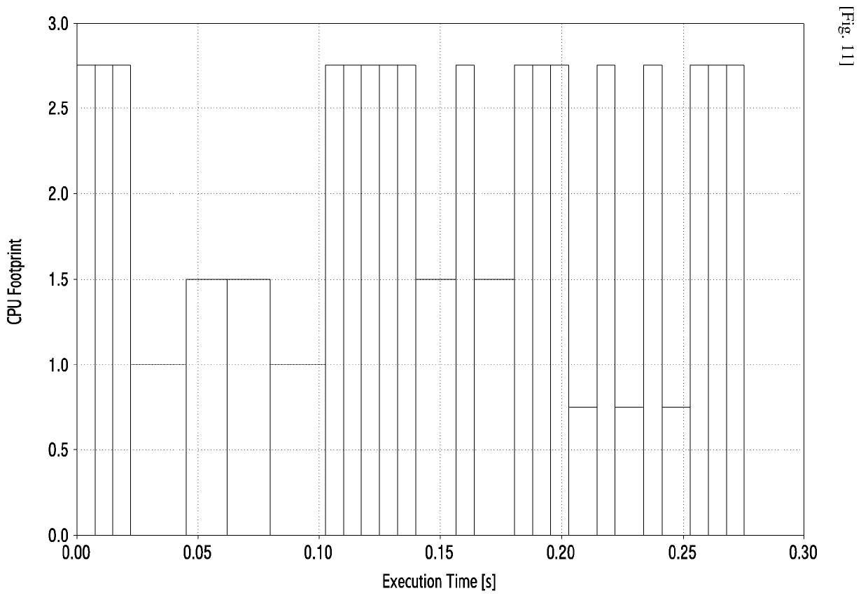

On the other hand, FIG. 11 shows the CPU footprint as a function of time of a procedure-based monolith. FIG. 11 illustrates a CPU footprint for a procedure-based monolith case according to embodiments of the present disclosure. In this case, as expected, 100% of the procedure execution time is dominated by a single monolith. Generally, to have a set of tasks that are short-lived ensures a high level of bin packing efficiency if compared to task sets consisting of longer tasks. Ultimately, embodiments of the invention can be used to define task sets consisting of short-lived tasks such as the one shown in FIG. 12 where each reference label (A, B, C, D, E, F, G, H, I J) relates to a single container image (containing a single microservice). FIG. 12 illustrates a CPU footprint for a microservice-based case according to embodiments of the present disclosure. For these reasons, at least, the benefits in terms of bin packing efficiency derived from embodiments of the invention is particularly evident if compared to a NF-or a procedure-based monolithic approach.

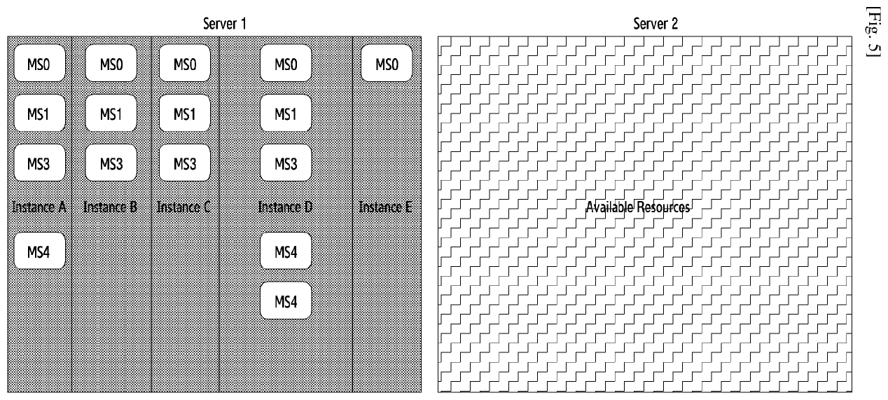

Embodiments of the invention, thanks to the MOA that monitors the amount of available bare-metal resources, provides a method to prompt the MCA to dynamically generate execution graphs of microservices to be grouped into the same container. In doing so, it is possible to increase the bin packing efficiency (as shown in FIG. 5) by adjusting the intra-container microservice execution graph, thereby adjusting the resources needed by each container to run. FIG. 5 illustrates an example of mapping of microservices (clustered in multiple container instances) onto two bare-metal servers according to embodiments of the present disclosure.

In the greater context of 6G core networks, embodiments of the invention enable the core to autonomously optimise its computational footprint by tracking the available bare-metal resources. This is particularly, compelling when the bare-metal resource pool involves several mid-to low-end servers located at the edge to support low latency procedures. This may be particularly useful in the case of the UE Registration procedure in massive access-type communication networks where hundreds of UEs may request to register to the network with tight latency constraints.

More generally, embodiments provide at least these advantages over the prior art:
Definition of MCA responsible for clustering the set microservices forming a 5GC. MCA
Gathers resource snapshots from the bare-metal;
Enacts re-clustering of microservices into containerised images;
Executes each containerised image making it sure that each replica will not exceed a given amount of bare-metal resources.
Definition of MIC, which caches containerised images.
Definition of MOA that oversees the creation of clusters of microservices by enforcing a clustering policy. MCA performs optimised clustering tasks by means of:
Non-AI-based optimisation policy
AI-based modules.
Definition of an NF (MCOF) logically grouping MCA, MIC and MOA.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

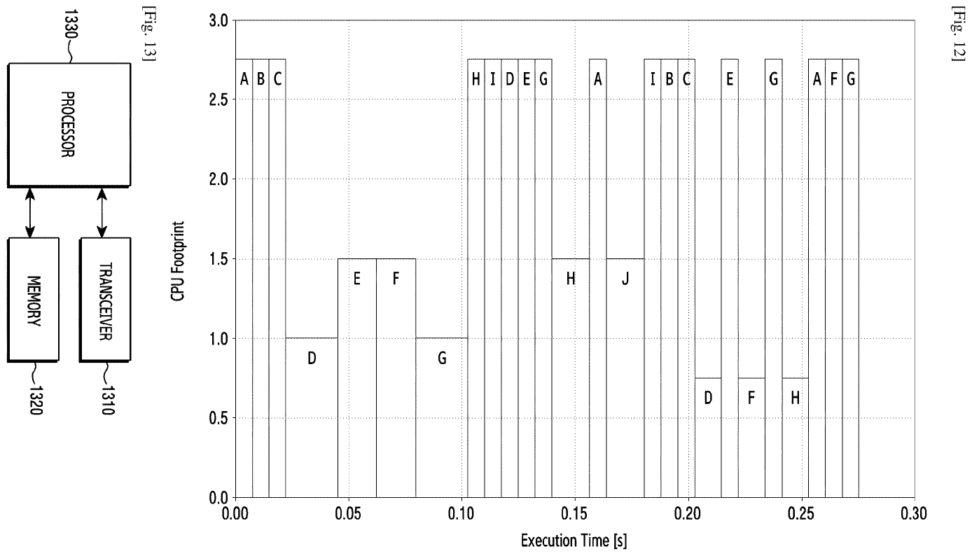

FIG. 13 is a block diagram illustrating a structure of a UE according to an embodiment of the disclosure.

As shown in FIG. 13, the UE according to an embodiment may include a transceiver 1310, a memory 1320, and a processor 1330. The transceiver 1310, the memory 1320, and the processor 1330 of the UE may operate according to a communication method of the UE described above. However, the components of the UE are not limited thereto. For example, the UE may include more or fewer components than those described above. In addition, the processor 1330, the transceiver 1310, and the memory 1320 may be implemented as a single chip. Also, the processor 1330 may include at least one processor. Furthermore, the UE of FIG. 13 corresponds to the UEs of FIG. 1.

The transceiver 1310 collectively refers to a UE receiver and a UE transmitter, and may transmit/receive a signal to/from a base station or a network entity. The signal transmitted or received to or from the base station or a network entity may include control information and data. The transceiver 1310 may include a RF transmitter for up-converting and amplifying a frequency of a transmitted signal, and a RF receiver for amplifying low-noise and down-converting a frequency of a received signal. However, this is only an example of the transceiver 1310 and components of the transceiver 1310 are not limited to the RF transmitter and the RF receiver.

Also, the transceiver 1310 may receive and output, to the processor 1330, a signal through a wireless channel, and transmit a signal output from the processor 1330 through the wireless channel.

The memory 1320 may store a program and data required for operations of the UE. Also, the memory 1320 may store control information or data included in a signal obtained by the UE. The memory 1320 may be a storage medium, such as read-only memory (ROM), random access memory (RAM), a hard disk, a CD-ROM, and a DVD, or a combination of storage media.

The processor 1330 may control a series of processes such that the UE operates as described above. For example, the transceiver 1310 may receive a data signal including a control signal transmitted by the base station or the network entity, and the processor 1330 may determine a result of receiving the control signal and the data signal transmitted by the base station or the network entity.

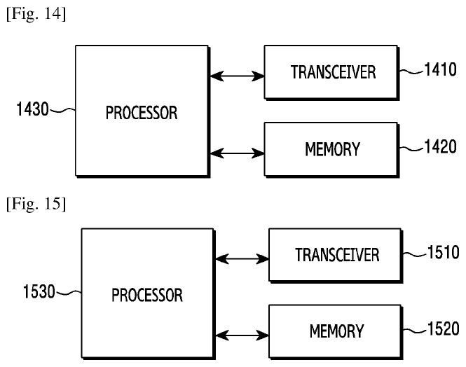

FIG. 14 is a block diagram illustrating a structure of a base station according to an embodiment of the disclosure.

As shown in FIG. 14, the base station according to an embodiment may include a transceiver 1410, a memory 1420, and a processor 1430. The transceiver 1410, the memory 1420, and the processor 1430 of the base station may operate according to a communication method of the base station described above. However, the components of the base station are not limited thereto. For example, the base station may include more or fewer components than those described above. In addition, the processor 1430, the transceiver 1410, and the memory 1420 may be implemented as a single chip. Also, the processor 1430 may include at least one processor.

The transceiver 1410 collectively refers to a base station receiver and a base station transmitter, and may transmit/receive a signal to/from a terminal (UE) or a network entity. The signal transmitted or received to or from the terminal or a network entity may include control information and data. The transceiver 1410 may include a RF transmitter for up-converting and amplifying a frequency of a transmitted signal, and a RF receiver for amplifying low-noise and down-converting a frequency of a received signal. However, this is only an example of the transceiver 1410 and components of the transceiver 1410 are not limited to the RF transmitter and the RF receiver.

Also, the transceiver 1410 may receive and output, to the processor 1430, a signal through a wireless channel, and transmit a signal output from the processor 1430 through the wireless channel.

The memory 1420 may store a program and data required for operations of the base station. Also, the memory 1420 may store control information or data included in a signal obtained by the base station. The memory 1420 may be a storage medium, such as read-only memory (ROM), random access memory (RAM), a hard disk, a CD-ROM, and a DVD, or a combination of storage media.

The processor 1430 may control a series of processes such that the base station operates as described above. For example, the transceiver 1410 may receive a data signal including a control signal transmitted by the terminal, and the processor 1430 may determine a result of receiving the control signal and the data signal transmitted by the terminal.

FIG. 15 is a block diagram illustrating a structure of a network entity (NE) according to embodiments of the present disclosure.

As shown in FIG. 15, the network entity of the present disclosure may include a transceiver 1510, a memory 1520, and a processor 1530. The transceiver 1510, the memory 1520, and the processor 1530 of the network entity may operate according to a communication method of the network entity described above. However, the components of the terminal are not limited thereto. For example, the network entity may include more or fewer components than those described above. In addition, the processor 1530, the transceiver 1510, and the memory 1520 may be implemented as a single chip. Also, the processor 1530 may include at least one processor. Furthermore, the network entity illustrated in FIG. 15 may correspond to the network entity (e.g., AMF entity or SMF entity illustrated in FIG. 1).

The transceiver 1510 collectively refers to a network entity receiver and a network entity transmitter, and may transmit/receive a signal to/from a base station or a UE. The signal transmitted or received to or from the base station or the UE may include control information and data. In this regard, the transceiver 1510 may include a RF transmitter for up-converting and amplifying a frequency of a transmitted signal, and a RF receiver for amplifying low-noise and down-converting a frequency of a received signal. However, this is only an example of the transceiver 1510 and components of the transceiver 1510 are not limited to the RF transmitter and the RF receiver.

Also, the transceiver 1510 may receive and output, to the processor 1530, a signal through a wireless channel, and transmit a signal output from the processor 1530 through the wireless channel.

The memory 1520 may store a program and data required for operations of the network entity. Also, the memory 1520 may store control information or data included in a signal obtained by the network entity. The memory 1520 may be a storage medium, such as ROM, RAM, a hard disk, a CD-ROM, and a DVD, or a combination of storage media.

The processor 1530 may control a series of processes such that the network entity operates as described above. For example, the transceiver 1510 may receive a data signal including a control signal, and the processor 1530 may determine a result of receiving the data signal.

The methods according to the embodiments described in the claims or the detailed description of the present disclosure may be implemented in hardware, software, or a combination of hardware and software.

When the electrical structures and methods are implemented in software, a computer-readable recording medium having one or more programs (software modules) recorded thereon may be provided. The one or more programs recorded on the computer-readable recording medium are configured to be executable by one or more processors in an electronic device. The one or more programs include instructions to execute the methods according to the embodiments described in the claims or the detailed description of the present disclosure.

The programs (e.g., software modules or software) may be stored in random access memory (RAM), non-volatile memory including flash memory, read-only memory (ROM), electrically erasable programmable read-only memory (EEPROM), a magnetic disc storage device, compact disc-ROM (CD-ROM), a digital versatile disc (DVD), another type of optical storage device, or a magnetic cassette. Alternatively, the programs may be stored in a memory system including a combination of some or all of the above-mentioned memory devices. In addition, each memory device may be included by a plural number.

The programs may also be stored in an attachable storage device which is accessible through a communication network such as the Internet, an intranet, a local area network (LAN), a wireless LAN (WLAN), or a storage area network (SAN), or a combination thereof. The storage device may be connected through an external port to an apparatus according the embodiments of the present disclosure. Another storage device on the communication network may also be connected to the apparatus performing the embodiments of the present disclosure.

In the afore-described embodiments of the present disclosure, elements included in the present disclosure are expressed in a singular or plural form according to the embodiments. However, the singular or plural form is appropriately selected for convenience of explanation and the present disclosure is not limited thereto. As such, an element expressed in a plural form may also be configured as a single element, and an element expressed in a singular form may also be configured as plural elements.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

A description of an embodiment with several components in communication with each other does not imply that all such components are required. On the contrary a variety of optional components are described to illustrate the wide variety of possible embodiments of the disclosure.

When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the disclosure need not include the device itself.

The specification has described a method and apparatus for selecting a selective security mode for applying selective security and flow management for selective security for User Equipment (UE) under mobility. Further, the specification has described a method and apparatus for flow management for selective security during the handover. The illustrated steps are set out to explain the embodiments shown, and it should be anticipated that on-going technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

1. A method performed by a network entity in a wireless communication system, the method comprising:
acquiring status information related to available bare-metal resources;
based on the status information, determining to re-cluster microservices into a plurality of containerised images; and
re-clustering the microservices.

2. The method of claim 1,
wherein the determining to re-cluster the microservices includes
identifying at least one of currently running containerised images to be terminated, and
wherein the re-clustering the microservices includes terminating the at least one of the currently running containerised images.

3. The method of claim 1,
wherein the re-clustering the microservices includes:
identifying at least one cached containerised image among the plurality of the containerised images;
generating other containerised images except the at least one cached containerised image among the plurality of the containerised images;

4. The method of claim 3,
wherein the re-clustering the microservices further includes:
deploying the generated other containerised images.

5. A method performed by a microservice clustering agent (MCA) entity in a wireless communication system, the method comprising:
acquiring status information related to available bare-metal resources;
transmitting the status information to microservice orchestrating agent (MOA) entity;
receiving re-cluster information for re-clustering microservices into a plurality of containerised images; and
re-clustering the microservices based on the re-cluster information.

6. The method of claim 5,
wherein the re-cluster information includes information indicating to terminate at least one of currently running containerised images, and
wherein the re-clustering the microservices based on the re-cluster information includes terminating the at least one of the currently running containerised images.

7. The method of claim 5,
wherein the re-clustering the microservices includes:
acquiring, via microservice image cache (MIC), at least one cached containerised image among the plurality of the containerised images,
wherein the MIC caches the at least one cached containerised image;
generating other containerised images except the at least one cached containerised image among the plurality of the containerised images;
updating the generated other containerised images to the MIC; and
deploying the generated other containerised images.

8. A network entity in a wireless communication system, the network entity comprising:
a transceiver;
a controller coupled with the transceiver and configured to:
acquire status information related to available bare-metal resources;
based on the status information, determine to re-cluster microservices into a plurality of containerised images; and
re-cluster the microservices.

9. The network entity of claim 8,
wherein the controller is further configured to:
identify at least one of currently running containerised images to be terminated, and
terminate the at least one of the currently running containerised images.

10. The network entity of claim 8,
wherein the controller is further configured to:
identify at least one cached containerised image among the plurality of the containerised images; and
generate other containerised images except the at least one cached containerised image among the plurality of the containerised images.

11. The network entity of claim 10,
wherein the controller is further configured to:
deploy the generated other containerised images.

12. A microservice clustering agent (MCA) entity in a wireless communication system, the MCA comprising:
a transceiver;
a controller coupled with the transceiver and configured to:
acquire status information related to available bare-metal resources;
transmit the status information to microservice orchestrating agent (MOA) entity;
receive re-cluster information for re-clustering microservices into a plurality of containerised images; and
re-cluster the microservices based on the re-cluster information.

13. The MCA entity of claim 12,
wherein the re-cluster information includes information indicating to
terminate at least one of currently running containerised images, and
wherein the controller is further configured to terminate the at least one of the currently running containerised images.

14. The MCA entity of claim 12,
wherein the controller is further configured to:
acquire, via microservice image cache (MIC), at least one cached containerised image among the plurality of the containerised images, wherein the MIC caches the at least one cached containerised image;
generate other containerised images except the at least one cached containerised image among the plurality of the containerised images; and
update the generated other containerised images to the MIC.

15. The MCA entity of claim 14,
wherein the controller is further configured to:
deploy the generated other containerised images.
